(19) United States
(12) Patent Application Publication
(10) Pub. No.: US 2008/0292831 A1
(43) Pub. Date: Nov. 27, 2008

(54) TUFTED PET FIBER FOR AUTOMOTIVE CARPET APPLICATIONS

(75) Inventors: Duane M. Juriga, Bloomfield Hills, MI (US); Robert E. Allen, Waterford, MI (US)

Correspondence Address: BUTZEL LONG;IP DOCKETING DEPT, 350 SOUTH MAIN STREET, SUITE 300, ANN ARBOR, MI, 48104, US

(73) Assignee: FUTURIS AUTOMOTIVE INTERIORS (US), INC., Troy, MI (US)

(21) Appl. No.: 12/147,753

(22) Filed: Jun. 27, 2008

Related U.S. Application Data
(63) Continuation-in-part of application No. 12/043,723, filed on Mar. 6, 2008.
(60) Provisional application No. 60/893,140, filed on Mar. 6, 2007.

(51) Int. Cl. B32B 33/00; B32B 37/00

(52) U.S. Cl. 428/91; 156/72; 28/214

(57) ABSTRACT

A tufted PET carpet assembly and a method of forming the same. The carpet assembly comprising a face layer comprised of polyethylene terephthalate (PET) yarn comprised of PET fibers and tufted at a pre-determined gauge, the face layer having a face weight, a first backing layer adjacent the face layer, and a first back coating layer adjacent the first backing layer. A method of forming a tufted PET carpet assembly with PET yarn comprising the steps of tufting the PET yarn at a pre-determined gauge onto a backing, applying a back coating to the tufted PET via extrusion to lock the tufted PET to the backing, and applying heat to the tufted PET to enhance the look and feel of the PET.

### CROSS-REFERENCE TO RELATED PATENT APPLICATIONS

This application is a continuation-in-part of co-pending U.S. patent application Ser. No. 12/043,723 filed Mar. 6, 2008, which claims the benefit of U.S. Provisional Patent Application No. 60/893,140, filed Mar. 6, 2007. Application Ser. No. 12/043,723 is co-pending at the time of filing of the present continuation-in-part, and the priority thereof is specifically claimed. The specification of Ser. No. 12/043,723 is incorporated herein by reference.

### BACKGROUND OF THE INVENTION

The present invention relates generally to vehicles and, more particularly, methods of producing carpeting utilized within vehicles.

In the automotive industry, carpeting is used for multiple purposes. One such purpose is noise attenuation since it is desirable to reduce the noise within a vehicle compartment. Various acoustical materials are used to reduce that noise which may be outside noises such as road noise, engine noise, vibrations, etc. These materials are used in dashboards, wheel wells, trunk compartments, under hoods, headliners, and especially carpeting floor panels. The acoustic properties of the carpeting floor panels are not the only considerations or functionality taken into account with respect to the carpeting panels. Such other considerations include the weight of the carpeting, the look of the carpeting, the cost of the carpeting and the feel (or the “hand”) of the carpeting. There are two main types of carpeting constructions used to attain these desired features.

Carpeting used in the automotive industry is typically tufted or nonwoven needle punch constructions. Tufted carpeting generally includes a composite structure in which tufts, or bundles of carpet fibers are introduced (such as by stitching) into a primary backing, such as a woven or non-woven fabric. These carpet fibers are typically a yarn consisting of nylon, polyester, wool or polypropylene, with nylon being the most common. A primary back coating of thermoplastic material is then applied to the underside of the carpet construction in order to securely retain the tufted material in the primary backing. This back coating not only dimensionally stabilizes the construction but may also provide greater abrasion and wear resistance, and may serve as an adhesive for an additional layer of material. Nonwoven carpet is composed of fiber that is mechanically entangled by needling, water jet, or other processes. Tufted nylon carpet has superior wear characteristics and as a result is generally preferred in North American automotive applications versus the less superior wear of the non-woven needle punch constructions which is generally preferred in European and Asian production markets.

Nylon has drawbacks however and there is always a desire to improve automotive carpet technology without increasing the cost of the carpet. This desire has lead to the development of alternative fibers being used in such carpet applications. One such alternative is polyethylene terephthalate (PET). PET fiber is made from PET chips, some of which come from recycled plastic containers. While PET is technically a polyester, it has a much higher melting point than polyester, which has been a drawback to the use of other polyesters. The melting point of PET is comparable to that of nylon. PET also has the potential to be recycled over and over. PET fiber also has a natural stain resistance quality which avoids the problem of nylon needing an application of a stain resistance chemical due to being inherently highly susceptible to staining. Additionally, PET stronger tear strength than nylon which is advantageous as it provides better scuff and tear resistance than traditional nylon carpets. For these and other reasons, PET seems to be a logical replacement for nylon in tufted automotive carpets. Unfortunately, though, current methods of forming PET carpet with PET as the face fiber (the top layer) result in carpeting that is not as durable as nylon or polypropylene carpet and is usually recommended only for light to moderate wear conditions and therefore is a drawback and preventing its acceptance and use for automotive applications. U.S. patent application Ser. No. 12/043,723, which is co-pending and incorporated herein by reference, discloses a PET carpet assembly and a method for forming the same that improves upon the many benefits and feature of nylon and non-woven needle punch constructions, however the appearance and feel of the PET carpet may not match some of the “luxury” nylon carpet assemblies.

Therefore, there is a need in the art for a method that results in a PET carpet that combines and improves upon the many benefits and features of nylon and non-woven needle punch constructions without increasing the cost to manufacture and yet matches or exceeds the appearance and feel of nylon and non-woven needle punch constructions.

### SUMMARY OF THE INVENTION

In view of the above discussion, a tufted PET carpet assembly and methods of forming the same are provided. According to one exemplary embodiment of the present invention, a tufted PET carpet assembly comprising a face layer comprised of polyethylene terephthalate (PET) yarn comprised of PET fibers and tufted at a pre-determined gauge, the face layer having a face weight, a first backing layer adjacent the face layer, and a first back coating layer adjacent the first backing layer.

According to a second exemplary embodiment of the present invention, a tufted PET carpet assembly comprising a face layer comprised of polyethylene terephthalate (PET) yarn comprised of PET fibers and tufted at a pre-determined gauge, the face layer having a face weight, a first backing layer adjacent the face layer, a first back coating layer adjacent the first backing layer, a second backing layer adjacent the first back coating layer, and an underlayment layer adjacent the second backing layer.

According to a third exemplary embodiment of the present invention, a method of forming a tufted PET carpet assembly with PET yarn comprising the steps of tufting the PET yarn at a pre-determined gauge onto a backing, applying a back coating to the tufted PET via extrusion to lock the tufted PET to the backing, and applying heat to the tufted PET to enhance the look and feel of the PET.

According to yet another exemplary embodiment of the present invention, a method of forming a carpet made from recycled material comprising the steps of utilizing tufted recycled PET fibers for the carpet facing, providing recycled PET for the primary backing, using a back coating formed of PE or latex in one of powder or sheet form, adding a scrim comprised of recycled PET, and attaching an insulator pad comprised of recycled PET.

It is one object of the present invention that the tufted PET carpet have wear characteristics that are superior to non-woven needle punch constructions and competitive with traditional nylon constructions.

It is another object of the present invention that the tufted PET carpet be naturally stain resistant and have moisture resistancy that is competitive with comparable nylon fibers.

It is yet another object of the present invention that the tufted PET carpet have color retention and fade resistance characteristics superior to or competitive with existing nylon fibers.

It is another object of the present invention that the tufted PET carpet consist at least partially of recycled materials.

It is yet another object of the present invention that the tufted PET carpet have competitive or superior sound absorption characteristics compared to traditional carpets.

It is another object of the present invention that the tufted PET carpet have the same of superior appearance and feel characteristics of convention nylon carpets.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a cross-sectional view of a preferred embodiment of a carpet in accordance with the present invention;

FIG. 2 is a cross-sectional view of an alternate embodiment of a carpet in accordance with the present invention; and

FIG. 3 is a schematic showing one exemplary method of forming tufted PET carpeting in accordance with the present invention.

### DESCRIPTION OF THE PREFERRED EMBODIMENT

The present invention relates generally to vehicles and, more particularly, tufted polyethylene terephthalate (PET) carpets and methods of producing the same for use within vehicles.

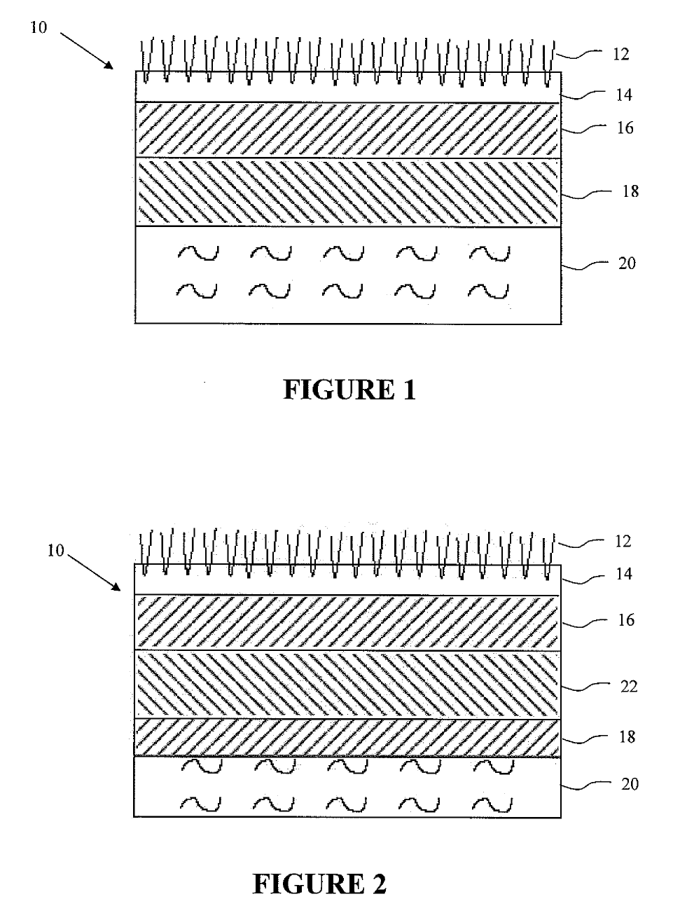

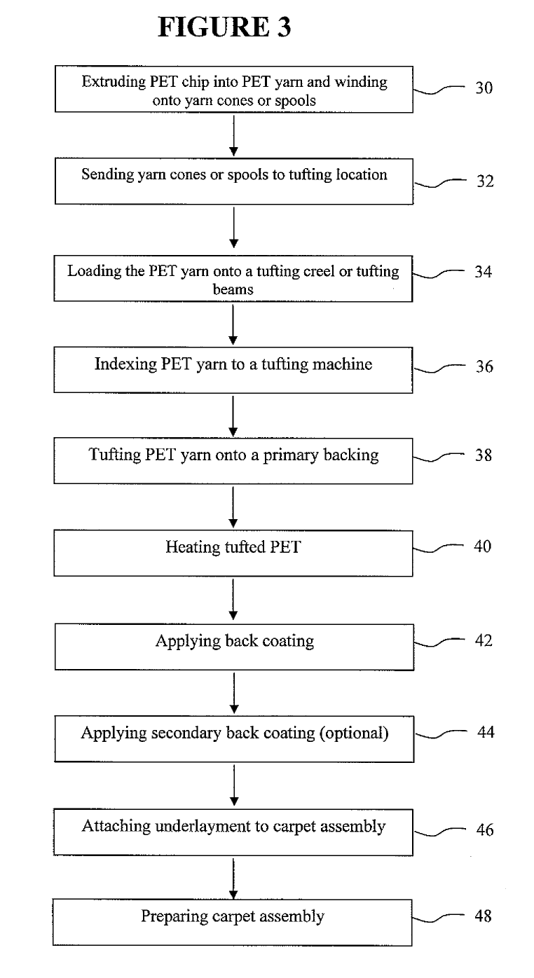

Referring to FIG. 1, an embodiment of a tufted carpet, generally illustrated at 10, is illustrated in accordance with the present invention. The carpet 10 has a carpet facing 12 that is backed by a primary backing 14. The carpet facing 12 which is the outward most layer that is seen and felt by the consumer is preferably formed of tufted PET while the primary backing 14 is preferably polyester, a polymer fiber such as a polyolefin (PE) or any other suitable synthetic fiber. The primary backing 14 to the carpet facing 12 is preferably formed of a polyester or spun bonded polyester blend scrim of 100-130 gsm. Adjacent to the primary backing 14 is a back coating 16 that is preferably in powder or sheet form, or any other suitable material commonly used in the art such as frothed latex, PE or acrylic. The next layer of the carpet 10 in the preferred embodiment shown in FIG. 1 is a secondary backing 18 which is preferably a lightweight scrim formed of polyester such as a PET. This secondary backing 18 is optional and may be included depending on various requirements placed on the carpeting such as moldability and sound attenuation. One skilled in the art will appreciate that the secondary backing 18 could be omitted without straying from the scope of this disclosure.

Finally, the carpet 10 preferably includes an underlayment 20. The underlayment 20 functions as an insulator pad as is commonly known in the art and is also preferably formed of PET. The cross-section for each layer 12, 14, 16, 18, and 20 is preferably uniform but may be varied. Further, the thickness of each particular layer is also preferably uniform across the entire carpet 10, however each layer may have a thickness that is different from the thickness of the other layers. Additionally, any number of additional layers may be added without straying from the scope of this disclosure. For example, referring to FIG. 2, to satisfy certain requirements a secondary back coating 22 could be utilized. This secondary back coating 22 could be located between the primary backing 14 and the second backing 18 and could consist of many types of materials such as PE or an EVA blend.

PET fiber as used in this invention can be manufactured from either virgin (nonrecyled) or recycled sources. For a variety of reasons, recycled PET sources are preferred for the scope of this invention even though one skilled in the art will appreciate that virgin PET sources may also be used with similar results. Further, PET fiber that ranges from 10-100% post consumer recycled material is preferred over 100% virgin sources because the recycled material is composed of high quality resins if derived from plastic beverage containers due to the fact that the United States Food and Drug Administration requires top quality resins to be used in the manufacturing of such plastic containers. Due to these high quality resins which improve the strength of the fiber, PET fiber that is manufactured from recycled plastic beverage containers typically results in a better quality tufted carpet when formed in accordance with the present invention. This distinguishes recycled PET from virgin PET and makes the use of recycled PET advantageous. Testing of yarn derived from such sources has exhibited that the fibers have exceptional strength and durability, which is important for its use in the automotive carpet industry. Further, these characteristics are not lost during the recycling process.

In addition to the typical considerations for automotive carpet systems such as durability, weight, cost sound absorption, etc., the use of recycled PET for the carpet of the present invention comes with an additional bonus feature over nylon—environmental friendliness. Utilizing the method disclosed herein, it is possible to create a “green” carpet 10 that is mainly comprised of post consumer recycled face fiber and materials which are readily recyclable at the endlife of the automotive carpet. An example of such a carpet 10 would mean that the carpet facing 12 is derived from recycled PET, the back coating 14 of PE, the second backing also of PET or a spun bound polyester scrim, and the underlayment 20 also from recycled PET. Finally, the use of recycled PET is not cost-prohibitive. Recycled and virgin PET is readily available in the material stream and provides cost advantages over nylon.

While the use of the recycled PET material is optimal and contemplated herein, this disclosure is not meant to limit the use of PET to only PET fiber that is made from 100% post consumer recycled material and anticipates that many different blends of source material may be utilized. Further, one skilled in the art will appreciate that sources of recycled material other than plastic beverage containers may also be utilized to carry out the invention.

Tufted PET for automotive carpets can be manufactured utilizing fiber diameters preferably ranging from about 800 to about 2400 denier and having filament counts ranging from about 40 to about 300. The most preferred combination, however, is a 1000 denier, 140 filament count construction which is 7.14 dpf (denier/fiber). The preferred face weight of the tufted PET can range from about 9.0 oz. per square yard to over 50.0 oz. per square yard. The carpet 10 can be manufactured on conventional tufting equipment as described herein, but the process preferably requires the use of a heating process after the carpet has been tufted in order to develop the “hand,” or the feel, of the material. Typical nylon carpet usually either does not need a special heating step due to the heat involved in the extrusion process or uses a steam box to steam the carpet. U.S. Ser. No. 12/043,723 discloses the use of a steam box to steam PET carpet to develop the hand of the carpet, but this method of heat is insufficient to fully develop the finer denier, higher filament count yarns contemplated for use by this disclosure. The traditional steam box typically reaches temperature of approximately 212° F. and only for a duration of about 10 to about 20 seconds. Tufted PET applications utilizing a fine denier and/or high filament count yarn require much more heating to “bulk” and develop the fibers than supplied by the steam box. Further, simply increasing the amount of time exposed to a steam box and/or using a super heated steam raises the risk of excess moisture being absorbed by the carpet.

Therefore, the heating step as disclosed herein is preferably utilizes an inferred heat or a convention heat source although one skilled in the art will appreciate that other types of heat sources may be used without straying from the scope of this disclosure. For example, it is anticipated that a form of contact heat could be utilized to develop the carpet. The carpet 10 is preferably exposed to heat in the range of about 212-300° F. for a period of between about 20-40 seconds. One skilled in the art will appreciate that these ranges may vary depending on the characteristics of the fiber being used and/or the heat source being used. The ability to fully develop the finer denier blend PET yarns allows for a larger diversification of carpet constructions and enhanced appearance capabilities than possible with U.S. Ser. No. 12/043,723. For example, the PET can be tufted in finer gage constructions such as 5/32 and 5/64 in order to provide a carpet assembly that has more detail and carpet pattern capabilities and improved wear characteristics.

As described hereinabove, the preferred method involves the introduction of a heating medium to fully develop the carpet facing 12. During processing, the PET yarn can be tufted into any gauge, for example ⅛, 1/10, 5/32, or 5/64. The finer denier blends provide for a more luxurious hand appearance. At comparable carpet face weights, tufted PET has approximately 20% more tufts per square inch than conventional tufted nylon. This higher density results in improved elimination of corn rowing (or ridging) as often experienced in carpets of lower density. Additional fiber strength and wear performance can be achieved with the tufted PET by adding additional geometry, such as looped and twisted yarns, to the fiber. Further, the carpet facing 12 could be cut-pile. Preferably, the filament count of the PET fiber is around 80-140 however that could vary without straying from the scope of the present invention. The fiber diameters of the tufted PET are typically finer than traditional nylon carpet and as a result, significant acoustical sound absorption advances are also anticipated by use of PET versus nylon. Micro-denier fiber technology may also allow the ability to tune interior vehicle acoustic performance at specific frequency ranges. For example, a micro-denier fiber layer (not shown) could be placed between the second backing 18 and the underlayment 20 to achieve different acoustic tendencies.

The tufting of specialized PET fibers, and preferably recycled PET fibers, is advantageous in the manufacturing of automotive carpet systems, including carpeted floors, inserts and auxiliary mats. One skilled in the art will appreciate that the carpeting 10 and the methods of forming tufted PET carpeting as disclosed herein are not limited to automotive applications and may also be applied for non-automotive applications such as commercial carpets, residential carpets, or airplane carpets.

The present disclosure also provides for a preferred method for forming the carpet 10. Referring now to FIG. 2, in accordance with the preferred method of manufacture as disclosed herein, in the first step 30, the PET chip (either virgin or recycled) is extruded into PET yarn and then wound onto yarn cones or spools. Then in 32, if not already there, the yarn cones or spools are sent to the tufting location. The next step of the method at 34 involves loading the yarn cones onto a tufting creel or rewinding the yarn onto tufting beams. Then, in 36 the yarn is pulled off of the tufting creel or beam and indexed into a tufting machine. Next, in step 38, the yarn is tufted onto a primary backing. Then, in step 40, the carpet 10 is heated to develop the hand of the material. This heating step 40 preferably involves the use of inferred heat, convection heat, contact heat, or another similar heating medium. After tufting and steaming, in step 42 a back coating such as a thin latex or frothed PE layer that is preferably 40-120 gms is applied to the yarn. This step 42 “tuftlocks” the PET yarn into the primary backing. Depending on the moldability and acoustic requirements for the carpet, an optional next step is applying a secondary back coating in step 44. This secondary back coating may consist of a polyethylene (PE) or ethylene vinyl acetate (EVA) blend. If a PE blend it preferably ranges from 200-800 gsm and if an EVA blend it preferably ranges from 800-2000 gsm. In step 46, an underlayment 20 is attached to the assembly. Finally, in step 48, once the carpet is completed, it can be prepared as necessary for the specific application. This step 48 may involve cutting the carpet and other necessary steps.

One skilled in the art will appreciate that the steps as listed above may vary or the order may change depending on the specific requirements of the carpet application. For example, the heating step 40 may occur earlier in the process. In addition, steps may be added to the process. For example, depending on moldability and acoustic requirements for the carpet, a secondary backing 18 can also be added. Such a secondary backing 18 typically consists of a lightweight scrim polyester or synthetic blend and preferably ranges from 15-100 gsm.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A lightweight carpet assembly comprising:
a face layer comprised of polyethylene terephthalate (PET) yarn, said yarn being composed of PET fibers, said face layer being tufted at a pre-determined gauge and having a face weight;
a backing layer adjacent said face layer; and
a back coating layer adjacent said backing layer.

2. The carpet assembly of claim 1 further comprising an underlayment layer.

3. The carpet assembly of claim 2 wherein said underlayment layer is composed of PET.

4. The carpet assembly of claim 1 wherein said PET yarn has a diameter between about 800 and about 2400 denier.

5. The carpet assembly of claim 1 wherein said face weight of said face layer ranges from about 9.0 oz. per square yard to about 50.0 oz. per square yard.

6. The carpet assembly of claim 1 wherein said face weight of said face layer is greater than 50.0 oz. per square yard.

7. The carpet assembly of claim 1 wherein said pre-determined gauge is one of ⅛, 1/10, 5/32, and 5/64.

8. The carpet assembly of claim 1 wherein said PET yarn of said face layer is one of looped, cut-pile, and twisted.

9. The carpet assembly of claim 1 wherein said backing layer is composed of at least one of a polyester and a polymer fiber.

10. The carpet assembly of claim 1 wherein said back coating layer is composed of a polymer fiber in one of a sheet form and a powder form.

11. The carpet assembly of claim 1 wherein said backing layer is a first backing layer, the carpet assembly further comprising a second backing layer.

12. The carpet assembly of claim 11 wherein said second backing layer comprises a PET scrim.

13. The carpet assembly of claim 1 wherein said back coating layer is a first back coating layer, the carpet assembly further comprising a second back coating layer adjacent said first back coating layer.

14. The carpet assembly of claim 13 wherein said second back coating layer is comprised of one of a PE and a ethylene vinyl acetate (EVA) blend.

15. A method of forming a tufted PET carpet assembly having PET yarn comprising the steps of:
tufting the PET yarn at a pre-determined gauge onto a backing;
applying a back coating to the tufted PET via extrusion to lock the tufted PET to the backing; and
applying heat to the tufted PET.

16. The method as set forth in claim 15 wherein the pre-determined gauge is one of ⅛, 1/10, 5/32, and 5/64.

17. The method as set forth in claim 15 wherein the PET yarn has a diameter between about 800 and about 2400 denier.

18. The method as set forth in claim 15 wherein the backing is comprised of at least one of a polyester and a polymer fiber.

19. The method as set forth in claim 15 wherein the back coating is comprised of a polymer fiber in one of a sheet form and a powder form.

20. The method as set forth in claim 15 wherein the heat is between about 212 and about 300 degrees Fahrenheit.

21. The method as set forth in claim 15 wherein the heat is applied for a length of time of about 20 to about 40 seconds.

22. The method as set forth in claim 15 wherein the heat is one of inferred heat, convection heat, superheated steam and contact heat.

23. A method of forming a carpet made from recycled material, the carpet having a facing and a primary backing, the method comprising the steps of:
utilizing tufted recycled PET fibers for the carpet facing;
providing recycled PET for the primary backing;
heating the tufted PET;
using a back coating formed of PE in one of powder or sheet form;
adding a scrim comprised of recycled PET; and
attaching an insulator pad comprised of recycled PET.

24. The method as set forth in claim 23 wherein the heat in the step of heating the tufted PET is between about 212 and about 300 degrees Fahrenheit.

25. The method as set forth in claim 23 wherein the heat in the step of heating the tufted PET is applied for a length of time of about 20 to about 40 seconds.

26. The method as set forth in claim 23 wherein the heat in the step of heating the tufted PET is one of inferred heat, convection heat, superheated steam and contact heat.
